(19) United States
(12) Patent Application Publication
(10) Pub. No.: US 2019/0250772 A1
(43) Pub. Date: Aug. 15, 2019

(54) SYSTEMS AND METHODS FOR FILTERING ELECTRONIC FILES DEFINING MEDIA CONTENT BASED ON A SOURCE OF THE MEDIA CONTENT

(71) Applicant: GOPRO, INC., San Mateo, CA (US)

(72) Inventors: Kris Skrinak, Carlsbad, CA (US); Craig Davidson, Cardiff, CA (US); Jean Cote, San Diego, CA (US)

(21) Appl. No.: 15/051,578

(22) Filed: Feb. 23, 2016

(51) Int. Cl. G06F 3/0481; G06F 3/16; G06F 3/0484

(52) U.S. Cl. CPC G06F 3/0481; G06F 3/04842; G06F 3/165

(57) ABSTRACT

Source criteria associated with a first set of one or more sources may be obtained such that electronic files defining media content generated by any source in the first source set include source information that satisfies the source criteria. The source information in electronic files may be compared with the source criteria to determine whether the electronic files were generated by any source in the first source set. Electronic files determined to have been generated by any source in the first source set may be presented to a user through a graphical user interface of a media player application. Electronic files determined to not have been generated by any source in the first source set may be hid from presentation within the graphical user interface of the media player application.

### FIELD

This disclosure relates to systems and methods for filtering electronic files defining media content based on a source of the media content.

### BACKGROUND

Users often have media content generated from multiple sources. Some media player applications will analyze files within an electronic folder (or other repository) for media files that are playable through the application. In this usage, the word “playable” may mean capable of being played by the media application. Generally, this analysis does not discriminate on anything other than media files of specific file formats.

### SUMMARY

This disclosure relates to filtering electronic files defining media content based on a source of the media content. The system may include storage media storing electronic files. The electronic files may define media content for playback. The electronic files may have been generated by one or more sources. The electronic files may include source information. Electronic files defining media content may be filtered based on a source of the media content by obtaining source criteria associated with a first set of the one or more sources such that electronic files generated by any source in the first source set include source information that satisfies the source criteria. The source information in the individual electronic files may be compared with the source criteria to determine whether individual ones of the electronic files were generated by any source in the first source set. Electronic files determined to have been generated by any source in the first source set may be presented to a user through a graphical user interface of a media player application. The media application may allow for selection by the user to commence playback of the media content defined by such electronic files. Electronic files determined to not have been generated by any source in the first source set may be hid from presentation within the graphical user interface of the media player application.

A system for filtering electronic files defining media content based on a source of the media content may include one or more of storage media, processors, and/or other components. The one or more processors may be configured to execute one or more computer program components. The computer program components may include one or more of a GUI presentation component, a source criteria component, a comparison component, a present component, a hide component, and/or other components.

The storage media may store electronic files. The electronic files may define media content for playback. The electronic files may have been generated by one or more sources. The electronic files may include source information related to the media content, playback of the media content, and/or generation of the electronic files. The electronic files may include a first electronic file. The first electronic file may define first media content for playback, the first electronic file having been generated by a first source. The first electronic file may include first source information related to the first media content, playback of the first media content, and/or generation of the first electronic file.

In some implementations, the first media content may include one or more of an audio, an image, a video, and/or other media content. In some implementations, the one or more sources may include one or more of a media capture tool, a media editing tool, and/or other sources. A media capture tool may include one or more of a media capture device, a media capture application, and/or other media capture tools. A media editing tool may include one or more of a media editing device, a media editing application, and/or other media editing tool.

The GUI presentation component may be configured to effectuate presentation on a display of a graphical user interface of a media player application. A user may be presented with playback of media content defined by the electronic files through the graphical user interface of the media player application.

The source criteria component may be configured to obtain source criteria associated with a first source set of the one or more sources. The electronic files generated by any source in the first source set may include source information that satisfies the source criteria.

In some implementations, the source criteria associated with the first source set may include a criterion based on a convention of naming of the electronic files generated by the one or more sources in the first source set. In some implementations, the source criteria associated with the first source set may include a criterion based on one or more formats of the electronic files generated by the one or more sources in the first source set. In some implementations, the source criteria associated with the first source set may include a criterion based on metadata included in the electronic files generated by the one or more sources in the first source set and generated by the one or more sources in the first source set at the generation of the electronic files. In some implementations, source criteria component may be further configured to select, based on a user input, the source criteria associated with the first set of the one or more sources.

The comparison component may be configured to compare the source information in the individual electronic files with the source criteria. Based on the comparison, the comparison component may be configured to determine whether individual ones of the electronic files were generated by any source in the first source set. In some implementations, the comparison component may be configured to determine that a new electronic file defining media content is stored in the storage media. The comparison component may be configured to compare the source information in the new electronic files with the source criteria. Based on the comparison, the comparison component may be configured to determine whether the new electronic file was generated by any source in the first source set.

The present component may be configured to, for electronic files determined to have been generated by any source in the first source set, effectuate presentation of such electronic files to the user through the graphical user interface of the media player application. The media application may allow for selection by the user to commence playback of the media content defined by such electronic files. In some implementations, the present component may be configured to, for a new electronic file determined to have been generated by any source in the first source set, effectuate presentation of the new electronic file to the user through the graphical user interface of the media player application. The media application may allow for selection by the user to commence playback of the media content defined by the new electronic file.

In some implementations, the electronic files may be stored in one or more directories inside the storage media. The one or more directories may include a first directory storing one or more of the electronic files. The present component may be further configured to, responsive to a selection of the first directory in the graphical user interface, effectuate presentation of the electronic files determined to have been generated by any source in the first source set and stored in the first directory.

The hide component may be configured to, for electronic files determined to not have been generated by any source in the first source set, hide such electronic files from presentation within the graphical user interface of the media player application. In some implementations, the hide component may be configured to, for the new electronic file determined to not have been generated by any source in the first source set, hide the new electronic file from presentation within the graphical user interface of the media player application.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for filtering electronic files defining media content based on a source of the media content.

FIG. 2 illustrates a method for filtering electronic files defining media content based on a source of the media content.

FIG. 3A illustrates an example of a graphical user interface displaying unfiltered electronic files defining media content.

FIGS. 3B-3G illustrate examples of a graphical user interface displaying filtered electronic files defining media content.

### DETAILED DESCRIPTION

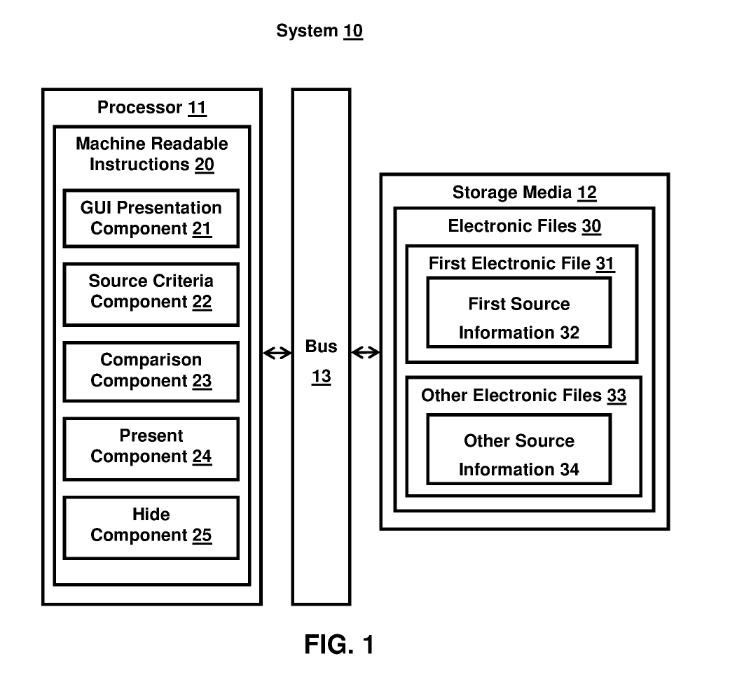

FIG. 1 illustrates system 10 for filtering electronic files defining media content based on a source of the media content. System 10 may include one or more of processor 11, storage media 12, bus 13, and/or other components. Storage media 12 may store electronic files 30. Electronic files 30 may define media content for playback. Electronic files 30 may have been generated by one or more sources. Electronic files 30 may include source information. Electronic files 30 defining media content may be filtered based on a source of the media content by obtaining source criteria associated with a first set of one or more sources such that electronic files generated by any source in the first source set include source information that satisfies the source criteria. The source information in individual electronic files may be compared with the source criteria to determine whether individual ones of the electronic files were generated by any source in the first source set. Electronic files determined to have been generated by any source in the first source set may be presented to a user through a graphical user interface (GUI) of a media player application. The media application may allow for selection by the user to commence playback of the media content defined by such electronic files. Electronic files determined to not have been generated by any source in the first source set may be hid from presentation within the graphical user interface of the media player application.

Storage media 12 may include electronic storage media that electronically stores information. Storage media 12 may store software algorithms, information determined by processor 11, information received remotely, and/or other information that enables system 10 to function properly. For example, storage media 12 may store information relating to electronic files, media content, sources, source criteria, and/or other information. System 10 may include electronic storage separate from storage media 12. Electronic storage separate from storage media may perform one or more of the functionalities of storage media 12 discussed above.

The storage media 12 may store electronic files 30. Electronic files 30 may define media content for playback. Playback of the media content may be effectuated through a graphical user interface. Electronic files 30 may have been generated by one or more sources. For example, one or more of electronic files 30 may have been generated by a source that captured the media content defined by electronic file(s) 30. As another example, one or more electronic files 30 may have been generated by a first source that captured the media content defined by electronic file(s) 30 and by a second source that edited/processed the media content defined by the electronic file(s).

Electronic files 30 may include source information related to the media content, playback of the media content, and/or generation of the electronic files. Source information may be generated before the generation of the electronic file(s), during the generation of the electronic file(s), or after the generation of the electronic file(s). Source information related to the media content may include information relating to the media content. Source information related to playback of the media content may include information that facilitates playback of the media content. Source information related to the generation of the electronic files may include information that facilitates determination of source(s) that generated the electronic files.

In some implementations, the one or more sources may include one or more of a media capture tool, a media editing tool, and/or other sources. A media capture tool may generate media content by capturing the media content. A media capture tool may generate electronic files defining the captured media content. A media editing tool may generate media content by editing the media content. A media editing tool may generate electronic files defining the edited media content. A media capture tool may include one or more of a media capture device, a media capture application, and/or other media capture tools. A media capture device may refer to one or more hardware, one or more hardware running one or more software, and/or other devices operating to generate media content/electronic files. A media capture application may refer to one or more software, one or more software running on one or more hardware to generate media content/electronic files, and/or other applications operating to capture media content through generation of electronic files. A media editing tool may include one or more of a media editing device, a media editing application, and/or other media editing tools. A media editing device may refer to one or more hardware, or one or more hardware running one or more software to edit media content and generate electronic files defining edited media content. A media editing application may refer to one or more software, or one or more software running on one or more hardware to edit media content and generate electronic files defining edited media content. A media capture tool and/or a media editing tool may correspond to a particular brand of hardware/software (e.g., GoPro, etc.), a particular family of device/software (e.g., GoPro Hero, GoPro Studio), a particular model/version of device/software, and/or other indicators associated with one or more sources.

For example, referring back to FIG. 1, electronic files 30 may include first electronic file 31. First electronic file 31 may define first media content for playback. In some implementations, the first media content may include one or more of an audio, an image, a video, and/or other media content. First electronic file 31 and/or the first media content may have been generated by a first source. First electronic file 31 may include first source information 32 related to the first media content, playback of the first media content, and/or generation of the first electronic file. As another example, electronic files 30 may include other electronic files 33. Other electronic file 33 may define other media content for playback. Other electronic files 33 and/or other media content may be been generated by other sources. Other electronic files 33 may include other source information 34 related to the source media content, playback of the other media content, and/or generation of the other electronic files 33.

Processor 11 may be configured to provide information processing capabilities in system 10. As such, processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. Processor 11 may be configured to execute one or more machine readable instructions 20 to facilitate the filtering of electronic files defining media content based on a source of the media content. Machine readable instructions 20 may include one or more of GUI presentation component 21, source criteria component 22, comparison component 23, present component 24, hide component 25, and/or other components.

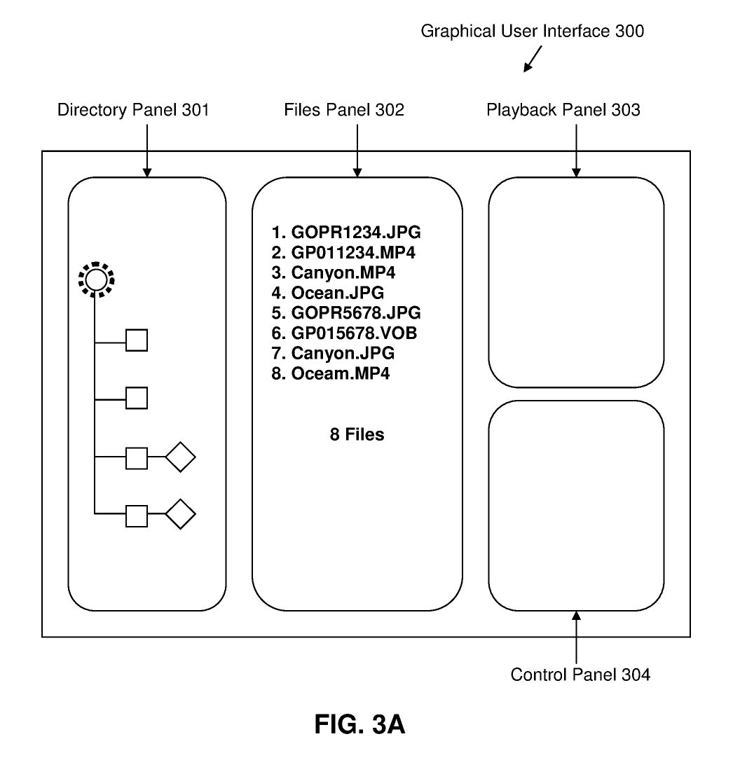

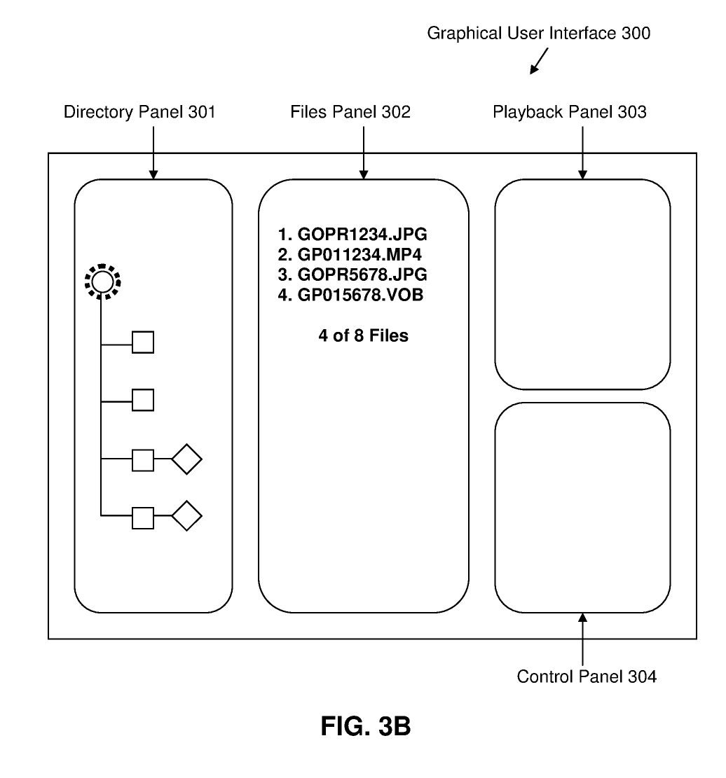

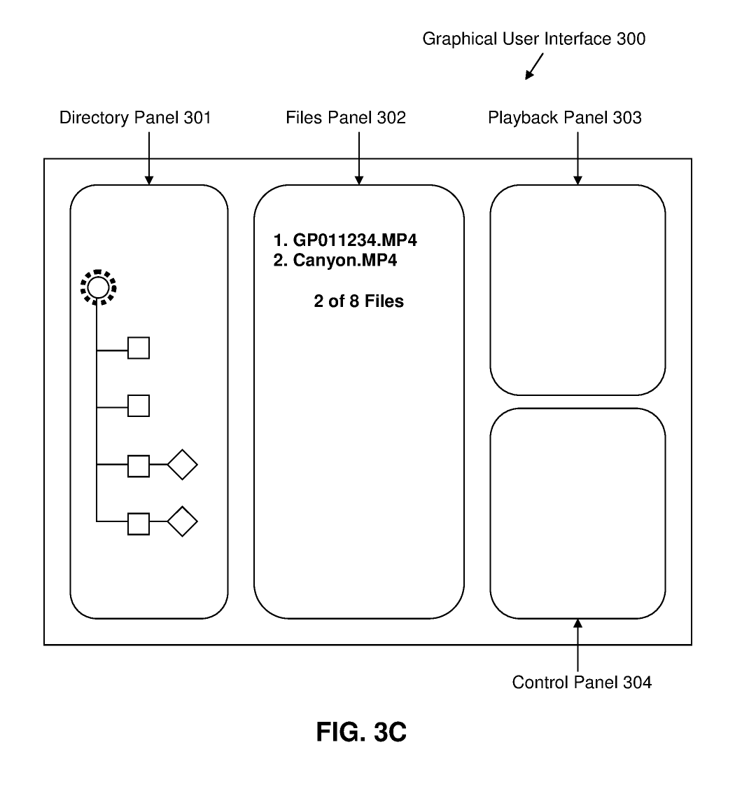

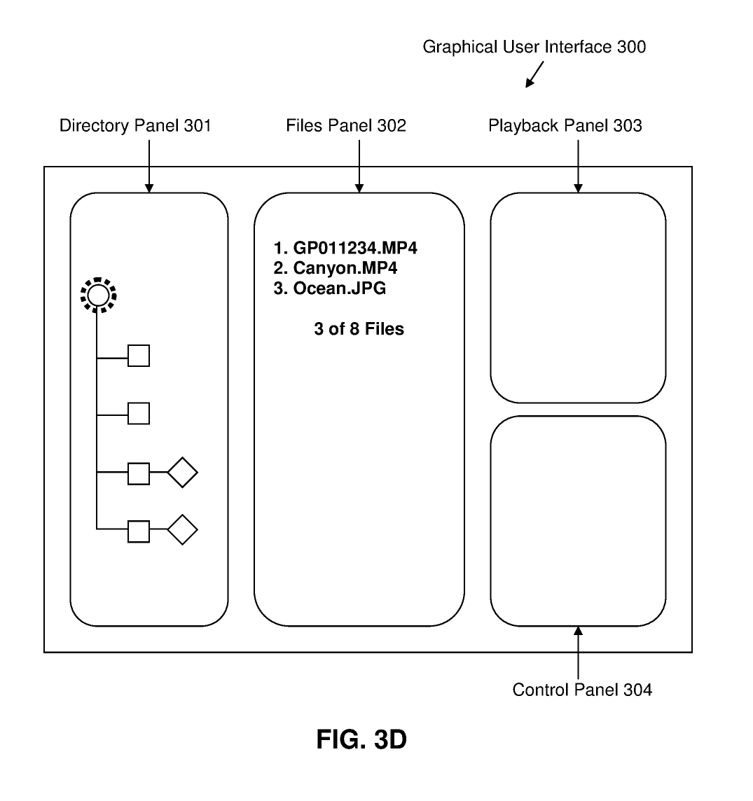

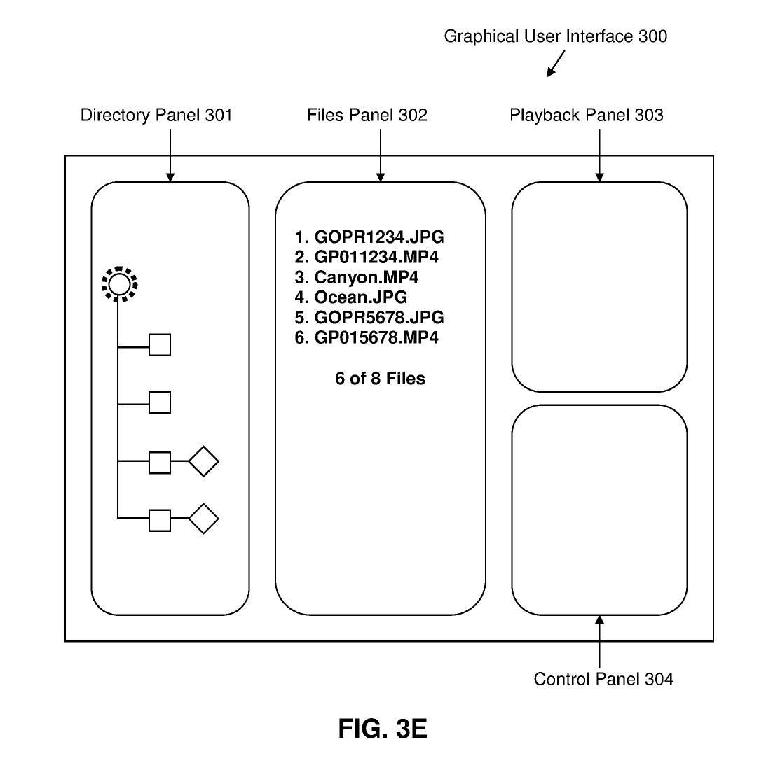

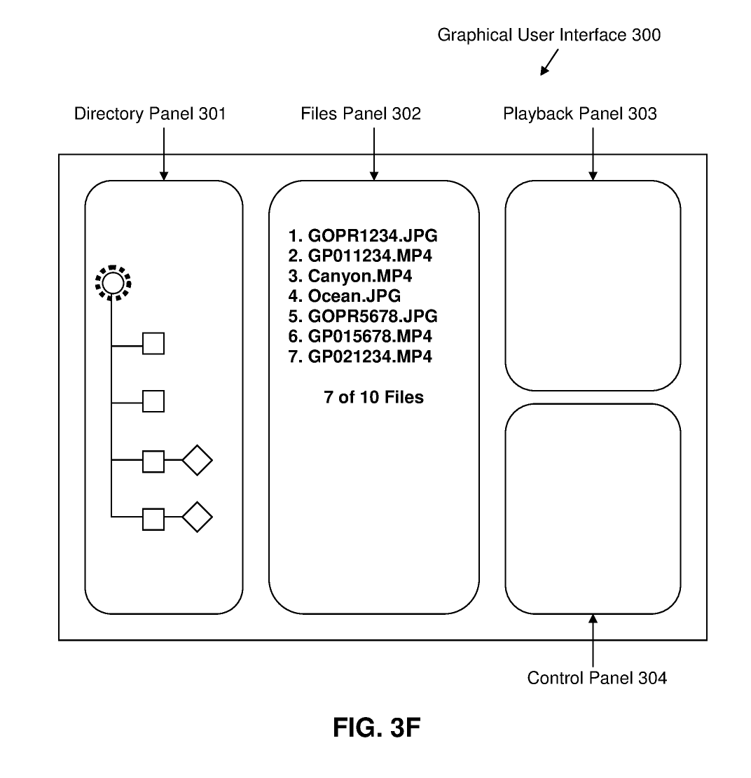

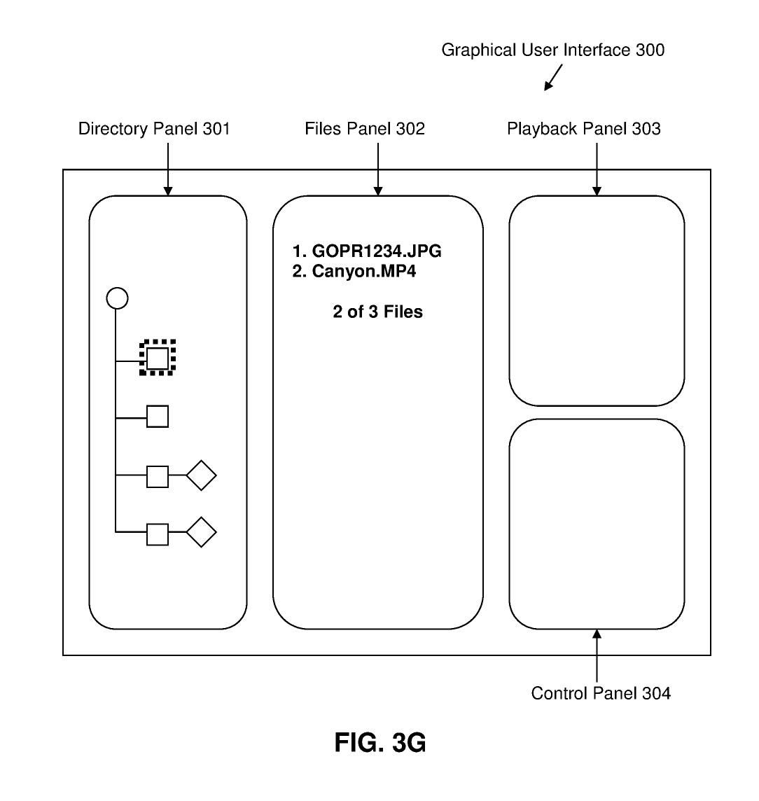

GUI presentation component 21 may be configured to effectuate presentation on a display of a graphical user interface of a media player application. The media application may allow for selection by the user to commence playback of the media content defined by the electronic files. A user may be presented with playback of media content defined by the electronic files through the graphical user interface of the media player application. For example, FIG. 3A illustrates an example of graphical user interface 300 of a media player application. Graphical user interface 300 may include one or more of directory panel 301, files panel 302, playback panel 303, control panel 304, and/or other panels. Individual panels of graphical user interface 300 may present different information. Other appearances and types of graphical user interface/panels are contemplated.

For example, directory panel 301 may present information related to a location of a storage media selected by a user. For example, in FIG. 3A, a user may have selected a root location of storage media 12. The root location of storage media 12 may be indicated by a circle and the user's selection may be indicated by a dotted circle. The selection of the root location may prompt presentation of directories inside the root location. For example, in FIG. 3A, the root location (indicated by a circle) may include four directory (indicated by squares). Two of the directories may each include a subdirectory (indicated by diamonds). Other types of information relating to a location of a storage media may be presented.

As another example, directory panel 301 may present information related to a media project selected by a user. A media project may refer to a compilation of changes made to one or more media content. For example, in FIG. 3A, a user may have selected a certain media project. The media project may be indicated by a circle and the user's selection may be indicated by a dotted circle. The selection of the media project may prompt presentation of directories inside the media project. For example, in FIG. 3A, the media project (indicated by a circle) may include four directories (indicated by squares). Two of the directories may each include a subdirectory (indicated by diamonds). Directories inside the media project may indicate different information related to the media project. For example, a directory may indicate different types of media content (e.g., image, audio, video, etc.), different types of edits to media content, different providers of media content, different time stamps of media content, and/or other information related to the media project. Other types of information relating to a media project may be presented.

As another example, files panel 302 may present information related to electronic files defining media content available for playback. In FIG. 3A, files panel 302 may present eight electronic files defining media content available for playback. In some implementations, electronic files presented in files panel 302 may correspond to a directory selected in directory panel 301. For example, eight electronic files presented in files panel 302 may be located in a root location/media project (indicated by a circle) selected in directory panel 301. As another example, eight electronic files presented in files panel 302 may be located in a root location/media project or in one or more directories located inside the root location/media project selected in directory panel 301. In some implementations, electronic files presented in files panel 302 may correspond to a directory selected in directory panel 301 and certain source(s).

In some implementations, electronic files presented in files panels 302 may correspond to one or more directories designated to be used for filtering electronic files defining media content based on a source of the media content. Such directories may be referred to as “watch directories” or “watch folders.” In some implementations, files panel 302 may present electronic files located in one or more watch directories. In some implementations, files panel 302 may present electronic files located in one or more watch directories and/or one or more subdirectories inside one or more watch directories. In some implementations, files panel 302 may present electronic files located in one or more watch directories and/or one of more subdirectories inside one or more watch directories, and determined to have been generated by certain source(s).

As another example, playback panel 303 may present playback of media content defined by electronic files selected in files panel 302. For example, a user may select electronic file “GOPR1234.JPG.” Responsive to the user's selection, playback panel 303 may display the image media content in GOPR1234.JPG or a preview of the image media content in GOPR1234.JPG. As another example, a user may select electronic file “GP011234.MP4.” Responsive to the user's selection, playback panel 303 may display the video media content in GP011234.MP4 or a preview of the video media content in “GP011234.MP4.” Playback panel 303 may display one or more images within GP011234.MP4 or display a play of GP011234.MP4. Other types of presentation of media content defined by electronic files are contemplated.

As another example, control panel 304 may present playback options for playback of media content presented in playback panel 303. Playback options may include one or more options to control the playback of media content by the media player application. As non-limiting examples, playback options may include one or more start, stop, pause, fast forward, rewind, next, previous, slow play, fast play, zoom in, zoom out, increase volume, decrease volume, mute, and/or other playback options. In some implementations, playback options may include one or more options to change the media content. Other types of playback options for media content are contemplated.

Source criteria component 22 may be configured to obtain source criteria associated with a first source set of one or more sources. Source criteria may be programmed into source criteria component 22, updated by source criteria component 22, obtained by source criteria component 22 from storage media 12 and/or other electronic storage, obtained by source criteria component 22 from remote location (e.g., a server, a network, etc.), and/or obtained by source criteria component 22 in other ways.

In some implementations, source criteria for a media player application may be set and may not be changed. In some implementations, source criteria for a media player application may not be set and may be changed. In some implementations, source criteria component 22 may be further configured to select, based on user input, the source criteria associated with the first set of one or more sources. User input may be received through the graphical user interface of the media player application and/or through other means.

Source criteria associated with a first set of one or more sources may refer to one or more features of electronic files generated by any source in the first source set. One or more features of electronic files generated by any source in the first source set may be descriptive of the electronic files and/or be a part of the electronic files. As non-limiting examples, source criteria may be based on the names of the electronic files, the formats of the electronic files, metadata in the electronic files, and/or other source criteria. The electronic files generated by any source in the first source set may include source information that satisfies the source criteria.

The source criteria associated with the first source set may include a criterion based on a convention of naming of the electronic files generated by one or more sources in the first source set. For example, Table 1 provides exemplary naming conventions for electronic files defining media content generated by GoPro media capture devices. Different types of media content may be associated with different naming convention.

For example, GoPro media capture devices may use the following naming convention for electronic files that define a single video or a single image: GOPRxxxx.mp4 or GOPRxxxx.jpg, where “xxxx” indicates the file number (e.g., second electronic file for a single image may be named “GOPR0002.jpg”). GoPro media capture devices may use the following naming convention for electronic files that define a chaptered video: GPzzxxxx.mp4, where “xxxx” indicates the file number and “zz” indicates the chapter number (e.g., electronic file for a second chapter of a chaptered video may be named “GP021234.mp4”). GoPro media capture devices may use the following naming convention for electronic files that define a burst/time-lapse image: Gyyyxxxx.jpg, where “yyy” indicates the group number and “xxxx” indicates the file number (e.g., electronic files for ten pictures in a group of shots may be named G0231111.jpg-G0231120.jpg). GoPro media capture devices may use the following naming conventions for electronic files that define a three-dimensional recording: 3D_Lxxxx.mp4 (left camera), 3D_Rxxxx.mp4 (right camera), where “xxxx” indicates the file number (e.g., electronic files for left and right videos of a 3D recording may be named “3D—L0002.mp4 and 3D_R0002.mp4, respectively). Other naming conventions are contemplated.

TABLE 1

| Recording Type | File Name | Example |
|---|---|---|
| Single Video | GOPRxxxx.mp4 | GOPR1234.mp4 |
| Single Image | GOPRxxxx.jpg | GOPR0002.jpg |
| | ‘xxxx’ = file number | |
| Chaptered Video | GPzzxxxx.mp4 | GP011234.mp4 (1st chapter |
| | ‘xxxx’ = file number | of the original video) |
| | ‘zz’ = chapter | GP021234.mp4 (2nd chapter |
| | number | of the same video) |
| Burst | Gyyyxxxx.jpg | Burst shot (10x pics): |
| Time-Lapse | ‘xxxx’ = file number | G0231111.jpg-G0231120.jpg |
| Image | ‘yyy’ = group number | Time-lapse shot (100x pics): |
| Looping Video | | G0241121.jpg-G0241221.jpg |
| 3D Recording | 3D_Lxxxx.mp4 (left | 3D videos: |
| | camera) | 3D_L0002.mp4 |
| | 3D_Rxxxx.mp4 (right | 3D_R0002.mp4 |
| | camera) | 3D Photos: |
| | ‘xxxx’ = file number | 3D_L1234.jpg |
| | | 3D_R1234.jpg |

The source criteria associated with the first source set may include a criterion based on one or more formats of the electronic files generated by one or more sources in the first source set. A format may refer to a particular arrangement in which media content is defined by electronic files. A particular arrangement in which media content is defined by electronic files may include the way in which information defining the media content is encoded for storage in the electronic files and/or the container in which the media content is stored. A format of the electronic files may correspond to a specific type of media content (e.g., PNG format, etc.) or may correspond to multiple types of media content (e.g., OGG format, etc.).

For example, video media content recorded by a GoPro media capture device (e.g., GoPro Hero, etc.) may be encoded using a H.264 codec and may be stored in a MP4 container. As another example, video media content processed by a GoPro media editing application (e.g., GoPro Studio, etc.) may be encoded using a GoPro/CineForm format and stored in a MXF container. Other formats are contemplated.

The source criteria associated with the first source set may include a criterion based on one or more metadata. Metadata may be included in the electronic files generated by one or more sources in the first source set. Metadata may be generated by one or more sources in the first source set at the generation of the electronic files. Metadata may refer to information associated with media content and/or one or more sources of the media content. Metadata may originate from one or more sources of the media content. For example, metadata may include information indicating that a media content was captured by one or more media capture tools and/or processed by one or more media editing tools. For example, an electronic file defining video media content generated by a GoPro media capture device (e.g., GoPro Hero, etc.) may include metadata indicating that the video media content was captured using the GoPro media capture device. As another example, an electronic file defining image media content generated by a GoPro media editing application (e.g., GoPro Studio) may include metadata indicating that the image media content was processed using the GoPro media editing application. Other metadata are contemplated.

Comparison component 23 may be configured to compare the source information in the individual electronic files with the source criteria. Comparison component 23 may compare source information related to the media content, playback of the media content, and/or generation of the electronic file with the source criteria.

For example, comparison component 23 may compare names of individual electronic files with a criterion based on a convention of naming of the electronic files generated by one or more sources in the first source set (e.g., comparing file names with naming convention for electronic files defining media content generated by a GoPro media capture device, etc.). As another example, comparison component 23 may compare formats of individual electronic files with a criterion based on one or more formats of the electronic files generated by one or more sources in the first source set (e.g., comparing formats of video media content files with GoPro/CineForm format). As another example, comparison component 23 may compare metadata of individual electronic files with a criterion based on one or more metadata generated by one or more sources in the first source set (e.g., comparing metadata in electronic files with metadata that would have been generated by GoPro Hero, etc.). Other comparisons of source information with source criteria are contemplated.

Based on the comparison, comparison component 23 may be configured to determine whether individual ones of the electronic files were generated by any source in the first source set. For example, in FIG. 3A, comparison component 23 may match names of electronic files “GOPR1234.JPG” and “GOPR5678.JPG” (presented in filed panel 302) to a naming convention of electronic files defining single images recorded by a GoPro media capture device (“GOPRxxxx”), and determine that the electronic files were generated by a GoPro media capture device (e.g., GoPro Hero, etc.). As another example comparison component 23 may match names of electronic files “GP011234.MP4” and “GP015678.VOB” to a naming convention of electronic files defining chaptered videos recorded by a GoPro media capture device (“GPzzxxxx”), and determine that the electronic files were generated by a GoPro media capture device (e.g., GoPro Hero, etc.). Names of other files listed in files panel 302 of FIG. 3A may not match a naming convention of electronic files defining media content captured by any source in the first source set (e.g., GoPro media capture device, etc.). FIG. 3B illustrates an exemplary list of electronic files defining media content determined to have been generated by one or more sources in the first source set based on the naming convention.

As another example, in FIG. 3A, comparison component 23 may determine that electronic files “GP011234.mp4” and “Canyon.mp4” define video media content encoded with GoPro/CineForm format. Comparison component 23 may match the GoPro/CineForm format to a format of electronic files defining media content generated by a GoPro media editing application and determine that the electronic files were generated by a GoPro media editing application (e.g., GoPro Studio, etc.). Formats of other files listed in files panel 302 of FIG. 3A may not match a format of electronic files defining media content generated by any source in the first source set (e.g., GoPro media editing application, etc.). FIG. 3C illustrates an exemplary list of electronic files defining media content determined to have been generated by one or more sources in the first source set based the format.

As another example, in FIG. 3A, comparison component 23 may determine that electronic files “GP011234.MP4,” “Canyon.MP4,” and “Ocean.JPG” include metadata indicating that the video and image media content were captured by one or more GoPro media capture tools and/or processed by one or more GoPro media editing tools. Metadata in other files listed in files panel 302 of FIG. 3A may not include metadata indicating that the electronic file was generated by any source in the first source set (e.g., GoPro media capture tools, GoPro media editing tools, etc.). FIG. 3D illustrates an exemplary list of electronic files defining media content determined to have been generated by one or more sources in the first source set based the metadata.

In some implementations, methodology described herein may be used to evaluate content (e.g., files in a folder) using information stored within a given file. Information stored within a given file may contain information relating to the content source. For example, information may include one or more of a keyword, a manufacturer's name, a camera version, and/or other information that may be used to describe the content source. By way of an illustration, a folder (directory) may contain multiple (e.g., 100,000) .mp4, .mov and/or .jog files. A content evaluation process may be used to identify one or more files (e.g, 4) captured and/or produced using GoPro hardware (e.g., camera) and/or software (e.g., mobile application, desktop studio software, and/or other applications).

In some implementations, the source criteria associated with the first source set may include criteria based on multiple features of electronic files defining media content generated by any source in the first source set. For example, the source criteria associated with the first source set may include a first criterion based a convention of naming of the electronic files defining media content and a second criterion based on metadata. The source criteria may require an electronic file to meet both the first criterion and the second criterion, meet the first criterion or the second criterion, or have one criterion take precedence over the other criterion.

For example, the source criteria associated with the first source set may include a first criterion based on a naming convention of electronic files defining media content recorded by a source in the first source set (e.g., GoPro media content capture tools and GoPro media content editing tools, etc.) and a second criterion based on one or more metadata generated by one or more sources in the first source set. The source criteria may be met if one or both of the first criterion and second criterion are met. FIG. 3E illustrates an exemplary list of electronic files defining media content determined to have been generated by one or more sources in the first source set based on the naming convention or the metadata.

As another example, source information in an electronic file may match source A for the first criterion and source B for the second criterion. Based on the source criteria, comparison component 23 may determine that the electronic file was generated by source A (e.g., the first criterion takes precedence over the second criterion), source B (e.g., the second criterion takes precedence over the first criterion), source A and source B (e.g., both the first criterion and the second criterion may be satisfied at the same time, for example, when an electronic file defines media content that was captured by a GoPro media capture device and edited by a GoPro media editing application)), or neither sources (e.g., conflicting indicators of sources lead comparison component 23 to determine that the electronic file was generated by neither source A or source B). Other combinations of source criteria and determination by comparison component 23 are contemplated.

In some implementations, comparison component 23 may be configured to determine that a new electronic file defining media content is stored in storage media 12. Comparison component 23 may check (e.g., at certain times, at certain intervals, or in response to a certain event, etc.) for new electronic files stored in storage media 12 or may be notified that new electronic files are stored in storage media 12. In some implementations, comparison component 23 may be configured to determine that a new electronic file defining media content is stored in one or more watch directories of storage media 12. In some implementations, comparison component 23 may be configured to determine that a new electronic file defining media content is stored in one or more watch directories and/or one or more subdirectories inside one or more watch directories.

Comparison component 23 may be configured to compare the source information in the new electronic files with the source criteria. Based on the comparison, comparison component 23 may be configured to determine whether the new electronic files were generated by any source in the first source set. For example, in FIG. 3F, comparison component 23 may determine that two new electronic files have been stored in storage media 12 and that, based on comparison of the source information in the new electronic files with the source criteria, one of the new electronic files (“GP021234.MP4”) was generated by a source in the first source set. FIG. 3F illustrates an exemplary list of electronic files that has been changed (from the exemplary list shown in FIG. 3E) to reflect the addition of two new electronic files in storage media 12.

Present component 24 may be configured to, for electronic files determined to have been generated by any source in the first source set, effectuate presentation of such electronic files to the user through the graphical user interface of the media player application. In some implementations, present component 24 may be configured to, for a new electronic file determined to have been generated by any source in the first source set, effectuate presentation of the new electronic file to the user through the graphical user interface of the media player application.

Presentation of electronic files may be effectuate through one or more visual information. Visual information may refer to one or more information that may be observed visually. Visual information may include one or more of an image, a video, and/or other visual information. For example, present component 24 may effectuate presentation of electronic files to the user through the graphical user interface via one or more of texts, numbers, images, videos, icons, and/or other visual information.

In some implementations, the electronic files defining media content may be stored in one or more directories inside storage media 12. For example, in FIG. 3E, one or more electronic files presented in files panel 302 may be stored in a root location of storage media 12 and/or one or more directories inside storage media 12. The one or more directories inside storage media 12 may include a directory storing one or more of the electronic files. For example, the first directory in storage media 12 (indicated by the first square in directory panel 301) may store electronic files “GOPR1234.JPG” and “Canyon.MP4.” The first directory in storage media 12 may also include another electronic file determined to not have been generated by any source in the first source set.

Present component 24 may be further configured to, responsive to a selection of the first directory in the graphical user interface, effectuate presentation of the electronic files determined to have been generated by any source in the first source set and stored in the first directory. FIG. 3G illustrates an exemplary list of electronic files that has been changed (from the exemplary list shown in FIG. 3E) to reflect the selection of the first directory in the graphical user interface and the electronic files in stored in the first directory.

Hide component 25 may be configured to, for electronic files determined to not have been generated by any source in the first source set, hide such electronic files from presentation within the graphical user interface of the media player application. In some implementations, hide component 25 may be configured to, for the new electronic file determined to not have been generated by any source in the first source set, hide the new electronic file from presentation within the graphical user interface of the media player application.

Hide component 25 may hide electronic files determined to not have been generated by any source in the first source set by omitting such electronic files from being presented in the graphical user interface through one or more visual information. In some implementations, hide component 25 may hide such electronic files by modifying one or more visual information related to such electronic files. For example, hide component 25 may change the color and/or brightness of the visual information relating to such electronic files. As another example, hide component 25 may add visual markers (e.g., strikethrough line(s)) to the visual information relating to such electronic files.

Although processor 11 and storage media 12 are shown to be connected to a bus 13 in FIG. 1, any communication medium may be used to facilitate interaction between any components of system 10. One or more components of system 10 may communicate with each other through hard-wired communication, wireless communication, or both. For example, processor 11 may wirelessly communicate with storage media 12. By way of non-limiting example, wireless communication may include one or more of radio communication, Bluetooth communication, Wi-Fi communication, cellular communication, infrared communication, or other wireless communication. Other types of communications are contemplated by the present disclosure.

Although processor 11 is shown in FIG. 1 as a single entity, this is for illustrative purposes only. In some implementations, processor 11 may comprise a plurality of processing units. These processing units may be physically located within the same device, or processor 11 may represent processing functionality of a plurality of devices operating in coordination.

Processor 11 may be configured to execute one or more of GUI presentation component 21, source criteria component 22, comparison component 23, present component 24, hide component 25, and/or other components by software; hardware; firmware; some combination of software, hardware, and/or firmware; and/or other mechanisms for configuring processing capabilities on processor 11.

It should be appreciated that although GUI presentation component 21, source criteria component 22, comparison component 23, present component 24, and hide component 25 are illustrated in FIG. 1 as being co-located within a single processing unit, in implementations in which processor 11 comprises multiple processing units, one or more of GUI presentation component 21, source criteria component 22, comparison component 23, present component 24, and/or hide component 25 may be located remotely from the other computer program components.

The description of the functionality provided by the different computer program components 21, 22, 23, 24, and/or 25 described herein is for illustrative purposes, and is not intended to be limiting, as any of computer program components 20, 21, 22, 23, 24, and/or 25 may provide more or less functionality than is described. For example, one or more of computer program components 20, 21, 22, 23, 24, and/or 25 may be eliminated, and some or all of its functionality may be provided by other computer program components 20, 21, 22, 23, 24, and/or 25. As another example, processor 11 may be configured to execute one or more additional computer program components that may perform some or all of the functionality attributed to one or more of computer program components 20, 21, 22, 23, 24, and/or 25.

The electronic storage media of storage media 12 may be provided integrally (i.e., substantially non-removable) with one or more components of system 10 and/or removable storage that is connectable to one or more components of system 10 via, for example, a port (e.g., a USB port, a Firewire port, etc.) or a drive (e.g., a disk drive, etc.). Storage media 12 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Storage media 12 may be a separate component within system 10, or storage media 12 may be provided integrally with one or more other components of system 10 (e.g., processor 11). Although storage media 12 is shown in FIG. 1 as a single entity, this is for illustrative purposes only. In some implementations, storage media 12 may comprise a plurality of storage units. These storage units may be physically located within the same device, or storage media 12 may represent storage functionality of a plurality of devices operating in coordination.

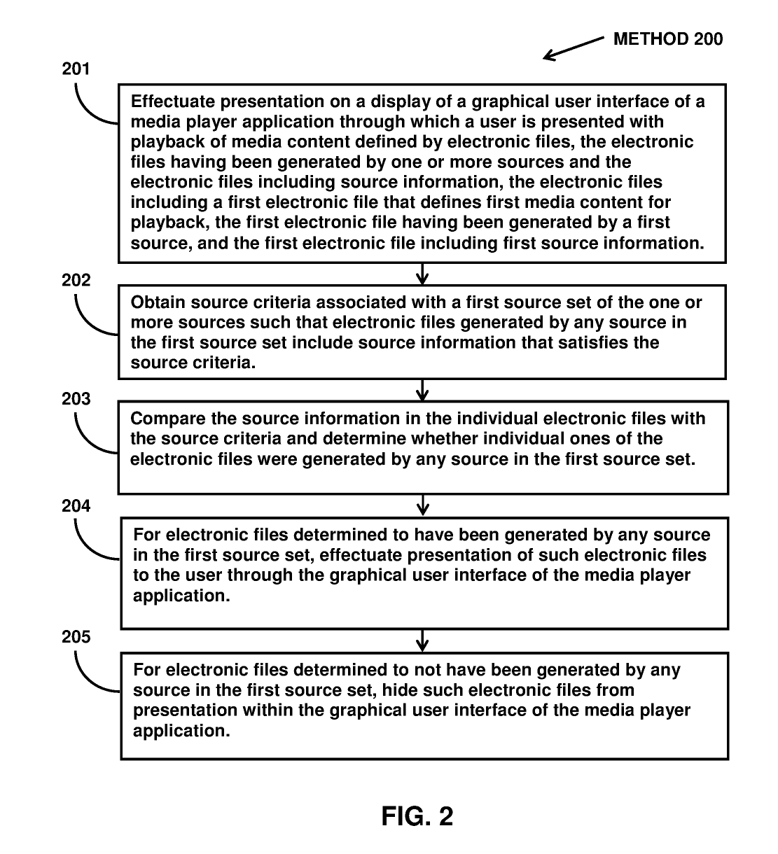

FIG. 2 illustrates method 200 for filtering electronic files defining media content based on a source of the media content. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage mediums. The one or more processing devices may include one or more devices configured through hardware, firmware, and/or software to be specifically designed for execution of one or more of the operations of method 200.

Referring to FIG. 2 and method 200, at operation 201, presentation on a display of a graphical user interface of a media player application may be effectuated. Through the graphical user interface, a user may be presented with playback of media content defined by electronic files. The electronic files may have been generated by one or more sources and the electronic files may include source information. The electronic files may include a first electronic file that defines first media content for playback, the first electronic file having been generated by a first source. The first electronic file may include first source information. In some implementations, operation 201 may be performed by a processor component the same as or similar to GUI presentation component 21 (shown in FIG. 1 and described herein).

At operation 202, source criteria associated with a first source set of the one or more sources may be obtained such that electronic files generated by any source in the first source set include source information that satisfies the source criteria. In some implementations, operation 202 may be performed by a processor component the same as or similar to source criteria component 22 (shown in FIG. 1 and described herein).

At operation 203, the source information in the individual electronic files may be compared with the source criteria to determine whether individual ones of the electronic files were generated by any source in the first source set. In some implementations, operation 203 may be performed by a processor component the same as or similar to comparison component 23 (shown in FIG. 1 and described herein).

At operation 204, presentation of electronic files determined to have been generated by any source in the first source set may be effectuated to the user through the graphical user interface of the media player application. In some implementations, operation 204 may be performed by a processor component the same as or similar to present component 24 (shown in FIG. 1 and described herein).

At operation 205, electronic files determined to not have been generated by any source in the first source set may be hid from presentation within the graphical user interface of the media player application. In some implementations, operation 205 may be performed by a processor component the same as or similar to hide component 25 (shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system for filtering electronic files defining media content based on a source of the media content, the system comprising:
storage media storing the electronic files that define the media content for playback, the electronic files having been generated by one or more sources, the electronic files including source information related to the media content, playback of the media content, and/or generation of the electronic files, the electronic files including a first electronic file that defines first media content for playback, the first electronic file having been generated by a first source, and the first electronic file including first source information related to the first media content, playback of the first media content, and/or generation of the first electronic file;
one or more processors configured by machine readable instructions to:
effectuate presentation on a display of a graphical user interface of a media player application through which a user is presented with playback of media content defined by the electronic files;
obtain source criteria associated with a first source set of the one or more sources such that electronic files generated by any source in the first source set include source information that satisfies the source criteria, wherein the source criteria associated with the first source set include a criterion based on a convention of naming of the electronic files generated by the one or more sources in the first source set;
determine, by comparing the source information in the individual electronic files with the source criteria, whether individual ones of the electronic files were generated by any source in the first source set; and
for electronic files determined to have been generated by any source in the first source set, effectuate presentation of such electronic files to the user through the graphical user interface of the media player application for selection by the user to commence playback of the media content defined by such electronic files; and
for electronic files determined to not have been generated by any source in the first source set, hide such electronic files from presentation within the graphical user interface of the media player application.

2. The system of claim 1, wherein the one or more sources include one or both of a media capture tool and/or a media editing tool.

3. (canceled)

4. The system of claim 1, wherein the source criteria associated with the first source set include a criterion based on one or more formats of the electronic files generated by the one or more sources in the first source set.

5. The system of claim 1, wherein the source criteria associated with the first source set include a criterion based on metadata included in the electronic files generated by the one or more sources in the first source set and generated by the one or more sources in the first source set at the generation of the electronic files.

6. The system of claim 1, wherein the one or more processors are further configured by machine readable instructions to select, based on a user input, the source criteria associated with the first set of the one or more sources.

7. The system of claim 1, wherein the first media content includes one or more of an audio, an image, and/or a video.

8. The system of claim 1, wherein the electronic files are stored in one or more directories inside the storage media, the one or more directories including a first directory storing one or more of the electronic files, and the one or more processors are further configured by machine readable instructions to, responsive to a selection of the first directory in the graphical user interface, effectuate presentation of the electronic files determined to have been generated by any source in the first source set and stored in the first directory.

9. The system of claim 1, wherein the one or more processors are further configured by machine readable instructions to:
determine that a new electronic file defining media content is stored in the storage media;
determine, by comparing the source information in the new electronic file with the source criteria, whether the new electronic file was generated by any source in the first source set;
responsive to a determination that the new electronic file has been generated by any source in the first source set, effectuate presentation of the new electronic file to the user through the graphical user interface of the media player application for selection by the user to commence playback of the media content defined by the new electronic file; and
responsive to a determination that the new electronic file has not been generated by any source in the first source set, hide the new electronic file from presentation within the graphical user interface of the media player application.

10. A method for filtering electronic files defining media content based on a source of the media content, the method comprising:
effectuating presentation on a display of a graphical user interface of a media player application through which a user is presented with playback of the media content defined by the electronic files, the electronic files having been generated by one or more sources, and the electronic files stored in a storage media and including source information related to the media content, playback of the media content, and/or generation of the electronic files, the electronic files including a first electronic file that defines first media content for playback, the first electronic file having been generated by a first source, and the first electronic file including first source information related to the first media content, playback of the first media content, and/or generation of the first electronic file;
obtaining source criteria associated with a first source set of the one or more sources such that electronic files generated by any source in the first source set include source information that satisfies the source criteria, wherein the source criteria associated with the first source set include a criterion based on a convention of naming of the electronic files generated by the one or more sources in the first source set;
comparing the source information in the individual electronic files with the source criteria and determining whether individual ones of the electronic files were generated by any source in the first source set; and
for electronic files determined to have been generated by any source in the first source set, effectuating presentation of such electronic files to the user through the graphical user interface of the media player application for selection by the user to commence playback of the media content defined by such electronic files;
for electronic files determined to not have been generated by any source in the first source set, hiding such electronic files from presentation within the graphical user interface of the media player application.

11. The method of claim 10, wherein the one or more sources include one or both of a media capture tool and/or a media editing tool.

12. (canceled)

13. The method of claim 10, wherein the source criteria associated with the first source set include a criterion based on one or more formats of the electronic files generated by the one or more sources in the first source set.

14. The method of claim 10, wherein the source criteria associated with the first source set include a criterion based on metadata included in the electronic files generated by the one or more sources in the first source set and generated by the one or more sources in the first source set at the generation of the electronic files.

15. The method of claim 10, further comprising selecting, based on a user input, the source criteria associated with the first set of the one or more sources.

16. The method of claim 10, wherein the first media content includes one or more of an audio, an image, and/or a video.

17. The method of claim 10, wherein the electronic files are stored in one or more directories inside the storage media, the one or more directories including a first directory storing one or more of the electronic files, and further comprising, responsive to a selection of the first directory in the graphical user interface, effectuating presentation of the electronic files determined to have been generated by any source in the first source set and stored in the first directory.

18. The method of claim 10, further comprising:
determining that a new electronic file defining media content is stored in the storage media;
comparing the source information in the new electronic file with the source criteria and determining whether the new electronic file was generated by any source in the first source set;
responsive to a determination that the new electronic file has been generated by any source in the first source set, effectuating presentation of the new electronic file to the user through the graphical user interface of the media player application for selection by the user to commence playback of the media content defined by the new electronic file; and
responsive to a determination that the new electronic file has not been generated by any source in the first source set, hiding the new electronic file from presentation within the graphical user interface of the media player application.

19. A system for filtering electronic files defining media content based on a source of the media content, the system comprising:
storage media storing the electronic files that define the media content for playback, the electronic files having been generated by one or more sources, the one or more sources including one or both of a media capture tool and/or a media editing tool, the electronic files including source information related to the media content, playback of the media content, and/or generation of the electronic files, the electronic files including a first electronic file that defines first media content for playback, the first media content including one or more of an audio, an image, and/or a video, the first electronic file having been generated by a first source, and the first electronic file including first source information related to the first media content, playback of the first media content, and/or generation of the first electronic file;
one or more processors configured by machine readable instructions to:
effectuate presentation on a display of a graphical user interface of a media player application through which a user is presented with playback of media content defined by the electronic files;
obtain source criteria associated with a first source set of the one or more sources such that electronic files generated by any source in the first source set include source information that satisfies the source criteria, wherein the source criteria associated with the first source set include a criterion based on a convention of naming of the electronic files generated by the one or more sources in the first source set;
determine, by comparing the source information in the individual electronic files with the source criteria, whether individual ones of the electronic files were generated by any source in the first source set; and
for electronic files determined to have been generated by any source in the first source set, effectuate presentation of such electronic files to the user through the graphical user interface of the media player application for selection by the user to commence playback of the media content defined by such electronic files; and
for electronic files determined to not have been generated by any source in the first source set, hide such electronic files from presentation within the graphical user interface of the media player application.

20. The system of claim 19, wherein the source criteria associated with the first source set further include a criterion based on one or more of one or more formats of the electronic files generated by the one or more sources in the first source set, and/or metadata included in the electronic files generated by the one or more sources in the first source set and generated by the one or more sources in the first source set at the generation of the electronic files.
